(19) United States
(12) Patent Application Publication
(10) Pub. No.: US 2026/0030986 A1
(43) Pub. Date: Jan. 29, 2026

(54) ELECTRONIC DEVICE PARKING METHOD AND DEVICE USING ULTRA-WIDEBAND COMMUNICATION

(71) Applicant: SAMSUNG ELECTRONICS CO., LTD., Suwon-si, Gyeonggi-do (KR)

(72) Inventors: Mingyu LEE, Suwon-si (KR); Sooyeon JUNG, Suwon-si (KR)

(21) Appl. No.: 18/993,430

(22) PCT Filed: Jul. 10, 2023
(86) PCT No.: PCT/KR2023/009791

§ 371 Date: Jan. 10, 2025

(30) Foreign Application Priority Data
Jul. 11, 2022 (KR) 10-2022-0085257

(51) Int. Cl. G08G 1/14; H04W 4/02; H04W 64/00

(52) U.S. Cl. CPC G08G 1/146; H04W 4/025; H04W 64/006

(57) ABSTRACT

An operation method of a first electronic device in a wireless communication system according to an embodiment of the present disclosure may comprise the steps of: transmitting a first message for activating autonomous driving-based parking (RSPA) of a second electronic device to the second electronic device; receiving measurement information of ultra-wideband (UWB) ranging performed by the second electronic device from the second electronic device; determining, on the basis of the measurement information of the UWB ranging, a target location at which the second electronic device will perform the autonomous driving-based parking; and indicating that the second electronic device will start the autonomous driving-based parking, and transmitting a second message including information on the target location to the second electronic device. The present disclosure may include various other embodiments.

### TECHNICAL FIELD

The disclosure relates to a method for controlling an electronic device using ultra-wideband (UWB) communication and, more specifically, to a technology proposing a smart parking method of an electronic device using ranging through UWB communication.

### BACKGROUND ART

The Internet is evolving from the human-centered connection network by which humans create and consume information to the Internet of Things (IOT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB). Meanwhile, a need arises for technology that assists smart parking of an electronic device using ranging technology between electronic devices.

### DETAILED DESCRIPTION OF THE INVENTION

### Technical Problem

The disclosure proposes a method for assisting autonomous driving-based parking of an electronic device using ranging technology via UWB communication.

### Technical Solution

According to an embodiment of the disclosure, a method for an operation by a first electronic device in a wireless communication system may comprise transmitting, to a second electronic device, a first message for activating autonomous driving-based parking (RSPA) of the second electronic device, receiving, from the second electronic device, measurement information for ultra-wideband (UWB) ranging performed by the second electronic device, determining a target location where the second electronic device is to perform the autonomous driving-based parking based on the measurement information about the UWB ranging, and transmitting, to the second electronic device, a second message instructing the second electronic device to start the autonomous driving-based parking and including information about the target location. According to an embodiment, the first electronic device may be a mobile terminal, and the second electronic device may be a vehicle.

According to an embodiment, the measurement information about the UWB ranging may include at least one of a distance (height) from a center point in the second electronic device to a ground, a distance from the center point in the second electronic device to the first electronic device, an angle of arrival (AOA) azimuth for the first electronic device from the center point in the second electronic device, and an AoA elevation value for the first electronic device from the center point of the second electronic device.

According to an embodiment of the disclosure, a method for an operation by a second electronic device in a wireless communication system may comprise receiving, from a first electronic device, a first message for activating autonomous driving-based parking (RSPA) of the second electronic device, transmitting, to the first electronic device, measurement information for ultra-wideband (UWB) ranging performed by the second electronic device, and receiving, from the first electronic device, a second message instructing the second electronic device to start the autonomous driving-based parking and including information about a target location where the second electronic device is to perform the autonomous driving-based parking.

According to an embodiment of the disclosure, a first electronic device in a wireless communication system comprises a transceiver and a controller. The controller may control to transmit, to a second electronic device, a first message for activating autonomous driving-based parking (RSPA) of the second electronic device. The controller may control to receive, from the second electronic device, measurement information for ultra-wideband (UWB) ranging performed by the second electronic device. The controller may determine a target location where the second electronic device is to perform the autonomous driving-based parking based on the measurement information about the UWB ranging. The controller may control to transmit, to the second electronic device, a second message instructing the second electronic device to start the autonomous driving-based parking and including information about the target location.

According to an embodiment of the disclosure, a second electronic device in a wireless communication system comprises a transceiver and a controller. The controller may control to receive, from a first electronic device, a first message for activating autonomous driving-based parking (RSPA) of the second electronic device. The controller may control to transmit, to the first electronic device, measurement information for ultra-wideband (UWB) ranging performed by the second electronic device. The controller may control to receive, from the first electronic device, a second message instructing the second electronic device to start the autonomous driving-based parking and including information about a target location where the second electronic device is to perform the autonomous driving-based parking.

### Advantageous Effects

An electronic device according to an embodiment of the disclosure may efficiently control autonomous driving-based parking for another electronic device using ranging technology via UWB communication.

An electronic device according to an embodiment of the disclosure may minimize user manipulation during autonomous driving-based parking and provide parking convenience using ranging technology through UWB communication.

### BRIEF DESCRIPTION OF THE DRAWINGS

FIG. 1 illustrates an example architecture of an electronic device according to an embodiment of the disclosure;

FIG. 2 illustrates a communication system including a plurality of electronic devices according to an embodiment of the disclosure;

FIG. 3 illustrates a method for performing communication by a plurality of electronic devices according to an embodiment of the disclosure;

FIG. 4 illustrates an example for describing an autonomous driving-based parking scheme of an electronic device according to an embodiment of the disclosure;

FIG. 5 illustrates an example of a method for manipulation by a user for autonomous driving-based parking of an electronic device according to an embodiment of the disclosure;

FIG. 6 illustrates another example of a method for manipulation by a user for autonomous driving-based parking of an electronic device according to an embodiment of the disclosure;

FIG. 7 illustrates examples of an environment in which an autonomous driving-based parking scheme of an electronic device is used according to an embodiment of the disclosure;

FIG. 8 is a view illustrating a user input process for autonomous driving-based parking of electronic devices according to an embodiment of the disclosure;

FIG. 9 is a view illustrating a method for measuring a distance and a direction based on UWB by electronic devices according to an embodiment of the disclosure;

FIG. 10 is a view illustrating an autonomous driving-based parking process of electronic devices according to an embodiment of the disclosure;

FIG. 11A is a flowchart illustrating a process in which electronic devices start autonomous driving-based parking according to an embodiment of the disclosure;

FIG. 11B is a flowchart illustrating a process in which electronic devices start autonomous driving-based parking according to an embodiment of the disclosure;

FIG. 12A is a flowchart illustrating a process of performing an operation related to autonomous driving-based parking according to a user request according to an embodiment of the disclosure;

FIG. 12B is a flowchart illustrating a process of performing an operation related to autonomous driving-based parking according to a user request according to an embodiment of the disclosure;

FIG. 13 illustrates a structure of a first electronic device according to an embodiment of the disclosure;

FIG. 14 illustrates a structure of a second electronic device according to an embodiment of the disclosure;

FIG. 15 is a flowchart illustrating an operation method of a first electronic device according to an embodiment of the disclosure; and

FIG. 16 is a flowchart illustrating an operation method of a second electronic device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. Further, although a communication system using UWB is described in connection with embodiments of the present invention, as an example, embodiments of the present invention may also apply to other communication systems with similar technical background or features. For example, a communication system using Bluetooth or ZigBee may be included therein. Further, embodiments of the present invention may be modified in such a range as not to significantly depart from the scope of the present invention under the determination by one of ordinary skill in the art and such modifications may be applicable to other communication systems.

When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Controller” may be a ranging device that defines and controls ranging control messages (RCM) (or control messages).

“Controllee” may be a ranging device using a ranging parameter in the RCM (or control message) received from the controller.

“Ranging device” may be a device capable of performing UWB ranging. In the disclosure, the Ranging Device may be an Enhanced Ranging Device (ERDEV) defined in IEEE 802.15.4z or a FiRa Device defined by FiRa. The Ranging Device may be referred to as a UWB device.

“Initiator” may be a Ranging Device that initiates a ranging exchange.

“Responder” may be a ranging device that responds to the Initiator in a ranging exchange.

“UWB message” may be a message including a payload IE transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“UWB channel” may be one of candidate UWB channels allocated for UWB communication. Candidate UWB channels allocated for UWB communication may be channels allocated for UWB communication defined in IEEE 802.15.4/4z. The UWB channel may be used for UWB ranging and/or transaction. For example, the UWB channel may be used for transmission/reception of a ranging frame RFRAME and/or transmission/reception of a data frame.

“Narrow band (NB) channel” may be a channel having a narrower bandwidth than the UWB channel. The NB channel may be a subchannel of one of the candidate UWB channels allocated for UWB communication. The NB channel may be a channel allocated for a communication technology other than UWB communication. The NB channel may be used for advertising, device discovery, and/or connection setup for additional parameter negotiation/authentication. For example, the NB channel may be used for transmission and reception of an advertisement message, an additional advertising message, a connection request message, and/or a connection confirmation message.

When determined to make the subject matter of the present invention unnecessarily unclear, the detailed description of related known functions or features may be skipped in describing the disclosure.

Hereinafter, various embodiments of the disclosure are described with reference to the accompanying drawings.

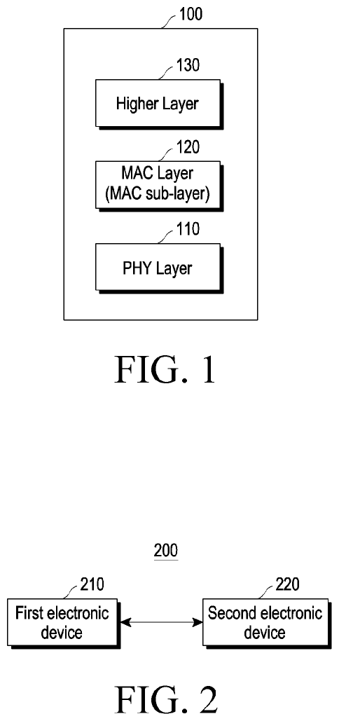

FIG. 1 illustrates an example architecture of an electronic device according to an embodiment of the disclosure.

In the disclosure, the electronic device may be one of various types of electronic devices. For example, the electronic device may be a portable device (e.g., a vehicle, a UE, a smartphone, a wearable device, or a tag device) or a stationary device (e.g., a door lock or an anchor device).

Referring to FIG. 1, the electronic device 100 may include a PHY layer 110, an MAC layer (MAC sublayer) 120, and/or a higher layer 130.

### (1) PHY Layer

The PHY layer 110 may include a low-level control entity and at least one transceiver. In this disclosure, the transceiver may be referred to as an RF transceiver or a radio transceiver.

As an embodiment, at least one transceiver may include a first transceiver supporting UWB communication (e.g., 802.15.4z-based UWB communication), a second transceiver supporting NB communication using a narrower bandwidth than that of UWB communication, and/or a third transceiver supporting other communication technologies (e.g., Wi-Fi or BLE). In this disclosure, the first transceiver may be referred to as a UWB transceiver. The second transceiver may be referred to as an NB transceiver. The third transceiver may be referred to as an out-of-band (OOB) transceiver. According to embodiments, one transceiver may support a plurality of communication technologies. For example, one transceiver may support UWB communication and NB communication.

In an embodiment, the PHY layer 110 may support at least one of the following functions.
Transceiver activation and deactivation function (transceiver on/off function)
Energy detection function
Channel selection function
Clear channel assessment (CCA) function
Synchronization function
Low-level signaling function
UWB ranging, positioning and localization functions
Spectrum resource management function
Function to transmit/receive packets through physical medium

### (2) MAC Layer

The MAC layer 120 provides an interface between the upper layer 130 and the PHY layer 120.

In an embodiment, the MAC layer 120 may provide two services as follows.
MAC data service: A service that enables transmission and reception of MAC protocol data unit (PDU) through the PHY
MAC management service: Service interfacing to MAC sublayer management entity (MLME) service access point (SAP) (MLME-SAP)

In an embodiment, the MAC layer 120 may support at least one of the following functions.
Device discovery and connection setup function
Channel access function (function of access to physical channel (e.g., NB channel/UWB channel/OOB channel))
Synchronization function
Interference mitigation function based on energy detection
Functions related to NB signaling
Guaranteed timeslot (GTS) management function
Frame delivery function
UWB ranging function
PHY parameter change notification function
Security function

### (3) Upper Layer

The upper layer 130 may include a network layer providing functions, such as network configuration and message routing, and/or an application layer providing an intended function of the device. In an embodiment, the application layer may be a UWB-enabled application layer for providing a UWB service.

FIG. 2 illustrates a communication system including a plurality of electronic devices according to an embodiment of the disclosure.

Referring to FIG. 2, a communication system 200 may include a first electronic device 210 and a second electronic device 220. As an embodiment, the first electronic device 210 and/or the second electronic device 220 may be the electronic device 100 of FIG. 1.

The first electronic device 210 may communicate with the second electronic device 220 for device discovery, connection setup, ranging (e.g., UWB ranging), data communication, and/or other purposes.

The first electronic device 210 may communicate with the second electronic device 220 according to a preset communication scheme (technology). For example, the first electronic device 210 may perform wireless communication with the second electronic device 220 using a UWB communication scheme, an NB communication scheme, and/or an OOB communication scheme.

In the disclosure, the UWB communication scheme may perform communication through at least one of candidate UWB channels allocated for UWB communication.

NB communication may support at least one NB channel having a narrower bandwidth than the UWB channel. In an embodiment, the NB channel may be a subchannel of one of the candidate UWB channels allocated for UWB communication. In an embodiment, the NB channel may be a subchannel of at least one of the channels allocated for wireless communication other than UWB communication.

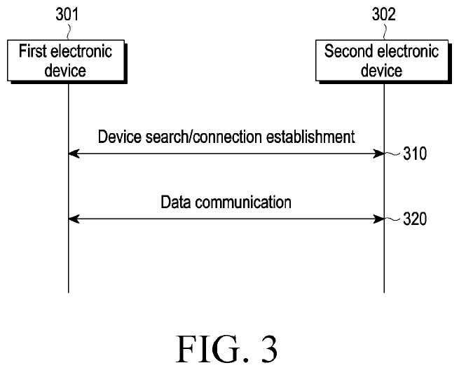

FIG. 3 illustrates a method for performing communication by a plurality of electronic devices according to an embodiment of the disclosure.

The first electronic device 301 and the second electronic device 302 of FIG. 3 may be, e.g., the electronic devices of FIG. 1 or 2.

Referring to FIG. 3, the first electronic device 301 and the second electronic device 302 may perform a device search/connection setup procedure 310 and a data communication procedure 320. The device search/connection setup procedure 310 and data communication procedure 320 may be managed or controlled by the MAC layer (entity) of the electronic device.

### (1) Device Search/Connection Setup Procedure

In the disclosure, the device search/connection setup procedure 310 may be a prior procedure performed before the data communication procedure 320. As an example, the device discovery/connection setup procedure 310 may be performed over OOB communication (channel), NB communication (channel), and/or UWB communication (channel).

The device search/connection setup procedure 310 may include at least one of the following operations.
Device discovery operation: An operation in which the electronic device searches for (discovers) another UWB devices. The device discovery operation may include an operation for transmitting/receiving an advertisement message. In the disclosure, the device discovery operation may be referred to as a discovery operation or an advertising operation.
Connection setup operation: An operation in which two electronic devices establish a connection. The connection setup operation may include an operation for transmitting/receiving a connection request message and a connection confirmation message. A connection (channel) established through the connection setup operation may be used to configure and control a UWB session for data communication. For example, parameters (e.g., UWB performance parameters (controllee performance parameters), UWB configuration parameters, session key-related parameters) for configuring a UWB session through a secure channel established through the connection setup operation may be negotiated between two electronic devices.

### (2) Data Communication Procedure

In the disclosure, the data communication procedure 320 may be a procedure for transmitting and receiving data using UWB communication. As an embodiment, the data communication procedure may be performed by UWB communication or NB communication.

The data communication procedure 320 may include at least one of the following operations.
UWB ranging operation: An operation in which the electronic device performs UWB ranging with another electronic device in a preset UWB ranging scheme (e.g., OWR, SS-TWR, DS-TWR scheme). As an embodiment, the UWB ranging operation may include a ToF measurement operation and/or an AoA measurement operation.
Transaction operation: An operation in which an electronic device exchanges service data with another electronic device.

In the disclosure, the first electronic device may control the second electronic device to move to the user's desired place through an autonomous driving-based operation in response to at least one input from the user.

The first electronic device is a device supporting UWB communication and may be, e.g., a terminal, a cellular phone, a smartphone having a wireless communication function, a personal portable assistant (PDA) having a wireless communication function, a wireless modem, or a portable computer having a wireless communication function. The second electronic device is a device supporting UWB communication and may be, e.g., a vehicle, a drone, a robotic arm, or an autonomous driving device.

According to an embodiment, the first electronic device and the second electronic device may measure the distance and/or direction therebetween based on UWB. At least one of the first electronic device and the second electronic device may determine a target location where the second electronic device is to move based on an autonomous driving-based operation based on a sensor.

According to an embodiment, the first electronic device may provide information about the distance and/or direction from the second electronic device to the target location to the second electronic device and request and/or control the second electronic device to move to the target location.

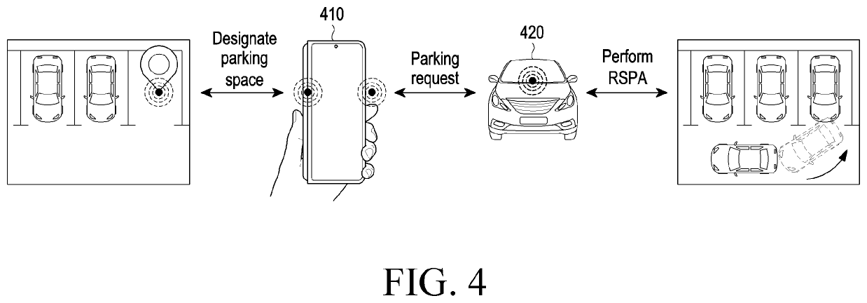

FIG. 4 illustrates an example for describing an autonomous driving-based parking scheme of an electronic device according to an embodiment of the disclosure.

The disclosure proposes a technology in which an electronic device performs autonomous driving parking (or remote smart parking assistant (RSPA)) based on UWB communication between electronic devices.

For example, 1) a method in which the user himself drives to move to the desired location, 2) a method in which the user moves the vehicle forward/backward to move to the desired location using a key fob, and 3) a method in which the user manipulates the autonomous driving function of the vehicle to move to the desired location may be used to park the electronic device (e.g., a vehicle).

With the recent development of autonomous driving technology, the usability of autonomous driving-based parking schemes (RSPA), such as 3) above, which provide enhanced convenience and accuracy compared to methods 1) and 2) above, is increasing. It is possible to enhance the usability as compared with the conventional RSPA by using UWB communication-based RSPA technology proposed in the disclosure. The UWB communication-based RSPA technology proposed in the disclosure enables parking in a narrow space or pulling out to wait at a specific location.

Referring to FIG. 4, the first electronic device 410 (e.g., a terminal) may designate a parking space where the second electronic device 420 (e.g., a vehicle) is to perform autonomous driving-based parking (RSPA) based on the user's first input. The first input may be an input defined in an application executed in the first electronic device 410.

The first electronic device 410 may transmit, to the second electronic device 420, a request message for allowing the user to park in a designated parking space based on the user's second input. The second input may be an input defined in an application executed in the first electronic device 410. The second electronic device 420 may perform autonomous driving-based parking (RSPA) into a parking space designated by the user in response to the request message.

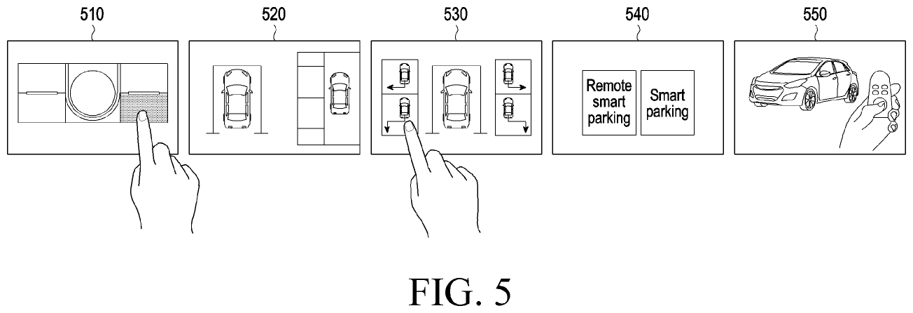

FIG. 5 illustrates an example of a method for manipulation by a user for autonomous driving-based parking of an electronic device according to an embodiment of the disclosure.

Referring to FIG. 5, the order of the user's manipulation in the electronic device for controlling the electronic device (e.g., a vehicle) to perform autonomous driving-based parking may be previously defined.

The electronic device may activate (510) the parking mode in response to a user input (e.g., a button input) to a button preset inside and provide (520) a screen for the user to search for a parking space on the display in the electronic device. The electronic device may select (530) a parking space where the electronic device is to perform autonomous driving-based parking in response to a user input (e.g., a touch input) to the parking space search screen provided on the display. The electronic device may switch (540) to gear P (parking) in response to a user input. Thereafter, the user may get out of the electronic device. The electronic device may perform (550) autonomous driving-based parking in response to a user input to the terminal (e.g., a key fob) controlling the electronic device.

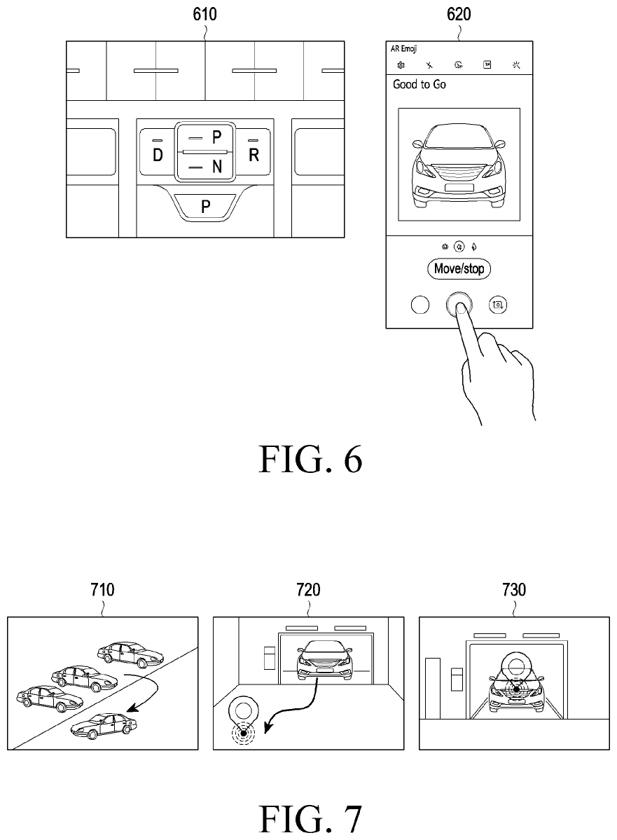

FIG. 6 illustrates another example of a method for manipulation by a user for autonomous driving-based parking of an electronic device according to an embodiment of the disclosure.

In FIG. 6, there is proposed an embodiment for minimizing user manipulation inside the second electronic device (e.g., a vehicle) using a user input to the first electronic device (e.g., a smartphone) through BLE and/or UWB communication between the first electronic device and the second electronic device.

The second electronic device may switch (610) to gear P (parking) in response to a user input (e.g., a button input). Thereafter, the user may get out of the second electronic device. An application for controlling autonomous driving-based parking of the second electronic device may be executed in the first electronic device. A screen for the user to search for a parking space on the display in the first electronic device may be provided, and the first electronic device may select (620) a parking space where the second electronic device is to perform autonomous driving-based parking in response to a user input (e.g., a touch input) to the parking space search screen provided on the display. The second electronic device may perform autonomous driving-based parking in response to a user input to the first electronic device controlling the second electronic device.

In FIG. 6, as user manipulation in the second electronic device is unnecessary, BLE and/or UWB communication-based RSPA has advantageous such as 1) easier search for a parking space and reduced parking time, 2) no limit to parking space, and 3) increased user safety and convenience.

First, the easier search for a parking space and reduced parking time may be achieved for the following reasons.
As no direct space search by the second electronic device (e.g., a vehicle) is required, parking mode switch/low-speed driving is unnecessary
Although the user gets out of the vehicle without separate manipulation of the second electronic device (e.g., a vehicle) when finding a parking space, the user may designate a parking space through the first electronic device (e.g., a smartphone)
Since the parking space search time is the longest in the parking time, the overall parking time reduces

Second, the reasons why there is no limit to parking space are as follows.
Since parking is possible at the location designated by the user, there is no limit to parking space (e.g., no need for parking lines, and no need for searching only for inter-vehicle spaces)
Even when pulling out, the second electronic device (e.g., a vehicle) may be rendered to wait at the location designated by the user.

Third, the reasons why user safety and convenience increases are as follows.
Parking is possible without the user aboard even in, e.g., a mechanical parking space, and accidents may be prevented
User convenience is enhanced by providing intuitive UX and reducing parking time.

FIG. 7 illustrates examples of an environment in which an autonomous driving-based parking scheme of an electronic device is used according to an embodiment of the disclosure.

It is possible to provide autonomous driving-based parking of the second electronic device (e.g., a vehicle) using a user input to the first electronic device (e.g., a smartphone) through BLE and/or UWB communication between the first electronic device and the second electronic device. In this case, it is possible to provide an efficient autonomous driving-based parking solution in such an environment as 1) pulling out from a narrow space (710), 2) pulling out from a mechanical parking space (720), or 3) parking in a mechanical parking space (730).

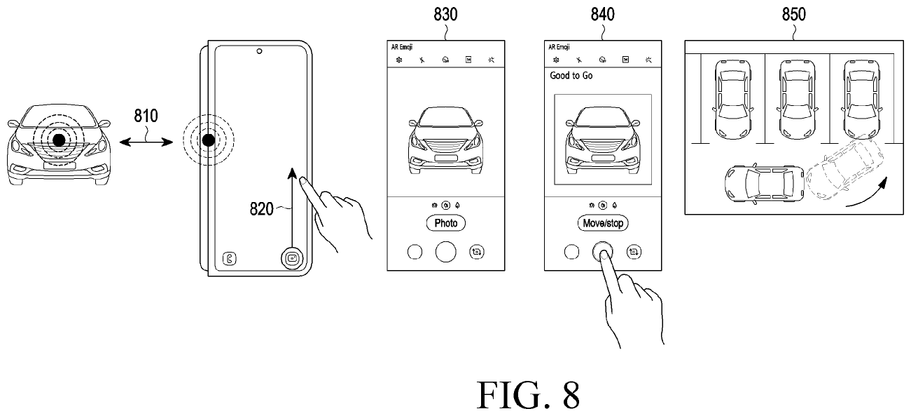

FIG. 8 is a view illustrating a user input process for autonomous driving-based parking of electronic devices according to an embodiment of the disclosure.

Referring to FIG. 8, the second electronic device (e.g., a vehicle) may perform autonomous driving-based parking using a user input to the first electronic device (e.g., a smartphone) through BLE and/or UWB communication between the first electronic device and the second electronic device.

In step 810, the first electronic device (e.g., a smartphone) and the second electronic device (e.g., a vehicle) may establish a BLE and UWB connection, and the user may get out of the second electronic device. The first electronic device may provide a digital key function for the second electronic device, and an application performing a digital key function in the first electronic device may be executed.

In step 820, the first electronic device may activate the camera application of the first electronic device for the user to designate a target location where the second electronic device is to park.

In step 830, the first electronic device may select a target vehicle which is the controlled target, i.e., the second electronic device, in response to a user input. In step 840, the first electronic device may designate (or determine) the target location where the second electronic device is to park in response to a user input to the screen provided by the camera application, and the first electronic device may transmit information about the target location and a move request to the second electronic device through UWB communication.

In step 850, the second electronic device may perform autonomous driving-based parking to the target location based on the information about the target location and the move request received from the first electronic device through UWB communication.

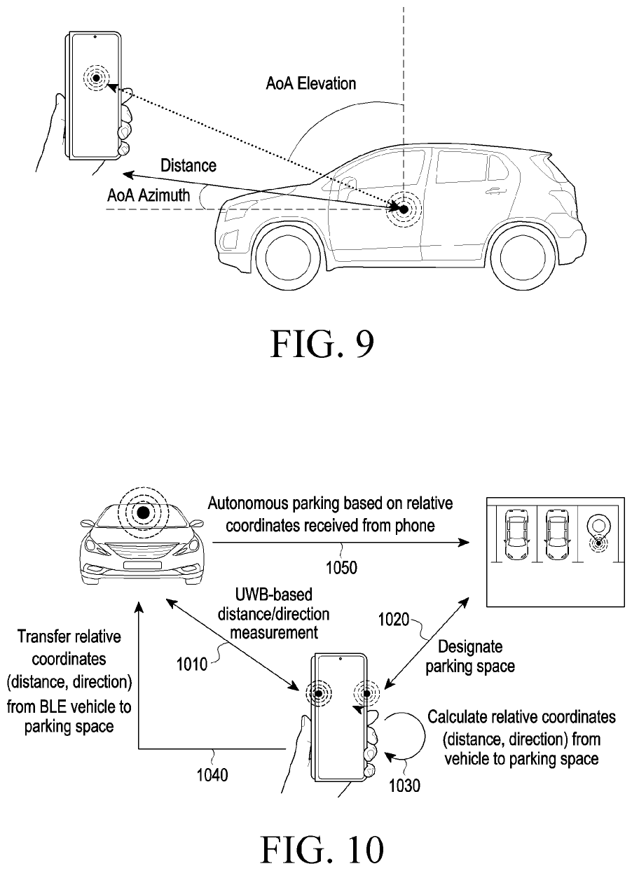

FIG. 9 is a view illustrating a method for measuring a distance and a direction based on UWB by electronic devices according to an embodiment of the disclosure.

During UWB ranging, the second electronic device (e.g., a vehicle) may obtain distance and/or direction information about the first electronic device (e.g., a smartphone) using a plurality of UWB anchors.

According to an embodiment, the second electronic device (e.g., a vehicle) may obtain the location of the first electronic device (e.g., a smartphone) relative to the center point, as the origin point, in the second electronic device (e.g., a vehicle) in the 3D coordinate system.

According to an embodiment, the second electronic device (e.g., a vehicle) may measure, through UWB ranging, the distance (height) from the center point in the second electronic device to the ground, the distance from the center point in the second electronic device to the first electronic device (e.g., a smartphone), the angle of arrival (AOA) azimuth for the first electronic device from the center point in the second electronic device, and the AoA elevation value for the first electronic device from the center point of the second electronic device. In this case, each value may be a value resultant from compensating for the inclination of the second electronic device according to the slope of the ground. According to an embodiment, the second electronic device may transmit, to the first electronic device, at least one of the measured height, distance, AOA azimuth, and AoA elevation.

FIG. 10 is a view illustrating an autonomous driving-based parking process of electronic devices according to an embodiment of the disclosure.

Referring to FIG. 10, in step 1010, the first electronic device (e.g., a smartphone) may measure UWB-based distance and/or direction for the second electronic device (e.g., a vehicle). According to an embodiment, the first electronic device (e.g., a smartphone) and the second electronic device (e.g., a vehicle) may support CCD Digital Key Phase 3.

According to an embodiment, the second electronic device (e.g., a vehicle) may obtain the distance and/or direction (angle of arrival) information with the first electronic device (e.g., a smartphone) and perform location measurement (phone localization) on the first electronic device (e.g., a smartphone). According to an embodiment, the first electronic device (e.g., a smartphone) may obtain the distance and/or direction information between the first electronic device and the second electronic device from the second electronic device (e.g., a vehicle).

In step 1020, the first electronic device (e.g., a smartphone) may designate a parking space for the second electronic device (e.g., a vehicle) in response to a user input. According to an embodiment, the first electronic device (e.g., a smartphone) may include an acceleration sensor for designating the parking space. According to an embodiment, the first electronic device (e.g., a smartphone) may designate the parking space for the second electronic device based on the distance and direction information between the first electronic device and the second electronic device obtained from the second electronic device (e.g., a vehicle) and the information obtained from the acceleration sensor. According to an embodiment, the first electronic device (e.g., a smartphone) may execute the camera application for parking space designation or vehicle selection in response to a user input or a predefined execution condition.

In step 1030, the first electronic device (e.g., a smartphone) may calculate the relative coordinates (distance and/or direction) from the second electronic device (e.g., a vehicle) to the parking space. According to an embodiment, the first electronic device (e.g., a smartphone) may calculate the moving distance and/or direction of the second electronic device (e.g., a vehicle) through a predefined algorithm. The method for calculating the moving distance and/or direction of the second electronic device (e.g., a vehicle) is not limited to the method proposed in the disclosure, but may be implemented in various manners.

In step 1040, the first electronic device (e.g., a smartphone) may transmit, to the second electronic device, information about the relative coordinates (distance and/or direction) from the second electronic device (e.g., a vehicle) to the parking space. According to an embodiment, the first electronic device (e.g., a smartphone) and the second electronic device (e.g., a vehicle) may support CCD Digital Key Phase 3 Remote Keyless Entry function. According to an embodiment, the first electronic device (e.g., a smartphone) and the second electronic device (e.g., a vehicle) may Wand-oriented BLE messages.

In step 1050, the second electronic device (e.g., a vehicle) may perform autonomous driving-based parking based on the information about the relative coordinates (distance and/or direction) received from the first electronic device (e.g., a smartphone).

Meanwhile, referring to CCD Digital Key Phase 3, the first electronic device (e.g., a smartphone) may discover and/or connect to the second electronic device (e.g., a vehicle) through BLE and then measure the distance through UWB ranging. According to an embodiment, by CCD Digital Key Phase 3, the first electronic device (e.g., a smartphone) may periodically measure the distance and direction of the second electronic device (e.g., a vehicle).

According to an embodiment, the first electronic device (e.g., a smartphone) may receive the distance and/or direction information from the second electronic device (e.g., a vehicle) and utilize BLE or UWB.

When the second electronic device (e.g., a vehicle) provides the distance and/or direction information using UWB, the first electronic device (e.g., a smartphone) may immediately receive information whenever ranging is performed. However, by the nature of the protocol, more operations may be required than when BLE is used—for example, the second electronic device (e.g., a vehicle) should select a specific anchor, and the specific anchor should receive, from the central processing unit in the second electronic device, a value (distance and/or direction) to be provided to the first electronic device (e.g., a smartphone).

According to an embodiment, it may be effective for the second electronic device (e.g., a vehicle) to transfer, through BLE, the location, distance, and/or direction information about the first electronic device (e.g., a smartphone) by referring to the information collected from the anchor. At the request of the first electronic device (e.g., a smartphone), the second electronic device (e.g., a vehicle) may provide the distance and/or direction information to the first electronic device using BLE.

According to an embodiment, the second electronic device (e.g., a vehicle) may provide the up-to-date distance and/or direction information to the first electronic device based on the user's explicit activation command in the first electronic device (e.g., a smartphone).

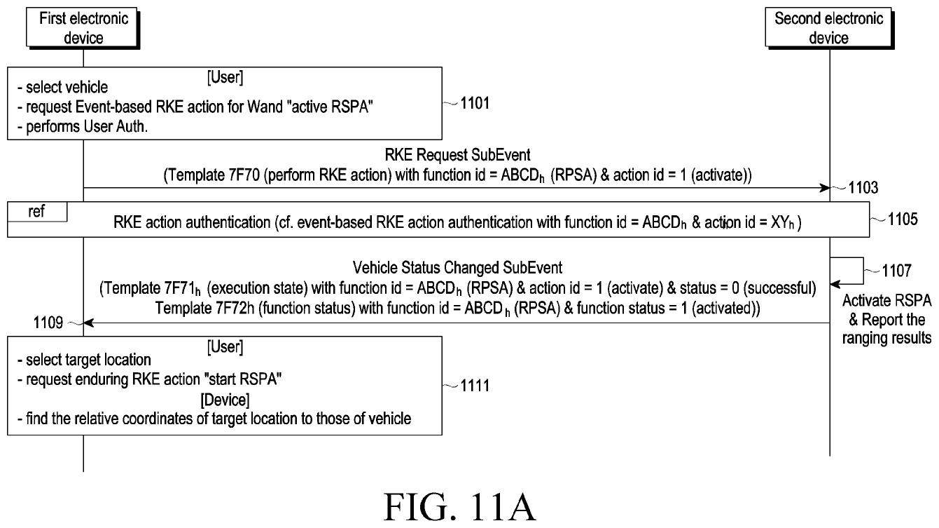

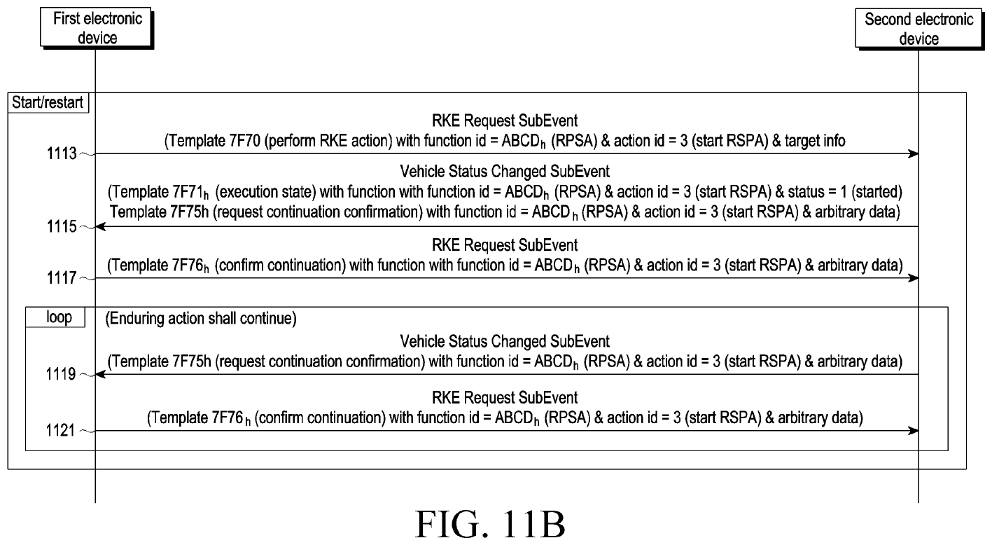

FIGS. 11A and 11B are flowcharts illustrating a process in which electronic devices start autonomous driving-based parking according to an embodiment of the disclosure.

Referring to FIG. 11A, in step 1101, the first electronic device (e.g., a smartphone) may select the second electronic device (e.g., a vehicle) which is the controlled target in response to a user input and determine to transmit, to the second electronic device, a request for the second electronic device to perform autonomous driving-based parking (RSPA) (request Event-based RKE action for Wand “activate RSPA”). According to an embodiment, the first electronic device (e.g., a smartphone) may determine to perform user authentication on the user of the second electronic device (e.g., a vehicle).

In step 1103, the first electronic device (e.g., a smartphone) may transmit, to the second electronic device (e.g., a vehicle), a message (RKE Request SubEvent) for requesting autonomous driving-based parking (RSPA) and activating autonomous driving-based parking (RSPA). For example, the RKE Request SubEvent message may be Template 7F70 for performing the RKE action in which “function id=ABCDₕ(RSPA) and action id=1 (activate)”.

In step 1105, the first electronic device (e.g., a smartphone) and the second electronic device (e.g., a vehicle) may perform authentication for RKE activation.

In step 1107, the second electronic device (e.g., a vehicle) may activate autonomous driving-based parking (RSPA) and transmit a report including the measurement value for the ranging result to the first electronic device (e.g., a smartphone).

In step 1109, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the autonomous driving-based parking (RSPA) function of the second electronic device is successfully activated.

For example, the Vehicle Status Changed SubEvent message may be Template 7F71 for performing an RKE action in which “function id=ABCDₕ(RSPA) and action id=1 (activate) and status=0 (successful)”. For example, the Vehicle Status Changed SubEvent message may be Template 7F72h for performing an RKE action in which “function id=ABCDₕ(RSPA) and function status=1 (activated)”.

In step 1111, the first electronic device (e.g., a smartphone) may select a target location where the second electronic device (e.g., a vehicle) is to perform autonomous driving-based parking (RSPA) in response to a user input, and determine to request the second electronic device to start autonomous driving-based parking (RSPA). The first electronic device (e.g., a smartphone) may identify (or search for) a relative distance (or relative coordinates) between the target location and the second electronic device (e.g., a vehicle).

Referring to FIG. 11B, in step 1113, the first electronic device (e.g., a smartphone) may request to start autonomous driving-based parking (RSPA) and transmit a message (RKE Request SubEvent) including information (target info) about the target location to the second electronic device (e.g., a vehicle). For example, the RKE Request SubEvent message may be Template 7F70 for performing an RKE action in which “function id=ABCDₕ(RSPA) and action id=3 (start RSPA) and target info”.

In step 1115, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the autonomous driving-based parking (RSPA) function of the second electronic device is started.

For example, the Vehicle Status Changed SubEvent message may be Template 7F71ₕ for an execution state in which “function id=ABCDₕ(RSPA) and action id=3 (start RSPA) and status=1 (started)”. For example, the Vehicle Status Changed SubEvent message may be Template 7F75h for requesting continuation confirmation in which “function id=ABCDₕ(RSPA) and action id=3 (start RSPA) and arbitrary data”.

In step 1117, the first electronic device (e.g., a smartphone) may transmit the RKE Request SubEvent message to the second electronic device (e.g., a vehicle). For example, the RKE Request SubEvent message may be Template 7F76h for confirm continuation in which “function id=ABCDₕ(RSPA) and action id=3 (start RSPA) and arbitrary data”.

In step 1119, the second electronic device (e.g., a vehicle) may transmit a message (Vehicle Status Changed SubEvent) indicating that the status of the vehicle is changed to the first electronic device (e.g., a smartphone). For example, the Vehicle Status Changed SubEvent message may be Template 7F75h for requesting continuation confirmation in which “function id=ABCDₕ(RSPA) and action id=3 (start RSPA) and arbitrary data”.

In step 1121, the first electronic device (e.g., a smartphone) may transmit the RKE Request SubEvent message to the second electronic device (e.g., a vehicle). For example, the RKE Request SubEvent message may be Template 7F76h for confirm continuation in which “function id=ABCDₕ(RSPA) and action id=3 (start RSPA) and arbitrary data”.

According to an embodiment, if the autonomous driving-based parking (RSPA) function of the second electronic device is successfully activated, the second electronic device may periodically transfer the distance and/or direction information collected from the UWB anchors through the BLE message. Here, the transfer of the BLE message may be maintained until the RSPA is deactivated.

Thereafter, the first electronic device may select a target location where the second electronic device is to perform autonomous driving-based parking in response to a user input and transmit a move request for the second electronic device. According to an embodiment, the first electronic device may provide the distance and/or direction information about the selected target location to the second electronic device and transmit a BLE message to the second electronic device to start RSPA.

According to an embodiment, the second electronic device may start autonomous driving-based parking (RSPA) and move to the target location while requesting or performing an enduring action. According to an embodiment, it is also possible to additionally perform started state reporting through Template 7F71 and 7F72. According to an embodiment, the movement of the second electronic device may be maintained until it receives a stop RSPA request from the first electronic device.

Table 1 below shows a description of parameters in a message for controlling RSPA.

TABLE 1

| | | | Possible function | | | |
|---|---|---|---|---|---|---|
| | | | status values | Event- | | Vehicle |
| | | | (range from 00ₕ to EFₕ, | based or | Device | Mandatory/ |
| Function | | | for values F0ₕ to FFₕ | enduring | Mandatory/ | Optional/ |
| id | Function | Possible action ids | of, Table XX) | action | Optional | Conditional |
| Among | RSPA | 0: De-Activate | 0: De-Activated | De-Active | 0 | 0 |
| 0600ₕ to | | (De-activate to send | 1: Activated | Event; over 6 | | |
| FFFFₕ | | ranging/AoA results | (Be Ready to send | meters away or | | |
| Vehicle | | and end RSPA. | ranging/AoA | Arrived at the | | |
| OEM- | | 1: Activate | results to | target point. | | |
| proprietary | | (Activate to send | keyfob/device | Start moving: | | |
| function) | | ranging/AoA results | and/or move | Enduring | | |
| | | to keyfob/device | to target point) | with/without | | |
| | | and/or move to | 2: Stopped | confirmation | | |
| | | target point) | 3: Started | | | |
| | | 2: Stop RSPA | | | | |
| | | 3: Start RSPA | | | | |
| | | 4: Reset Target | | | | |

Referring to Table 1, Function id is selected from among 0600ₕ to FFFFₕ, and this may be a vehicle OEM dedicated function, and Function may indicate RSPA.

action id may be set to one of 0 to 4. For example, “action id=0” may indicate the deactivation of RSPA, “action id=1” may indicate the activation of RSPA, “action id=2” may indicate the stop of RSPA, “action id=3” may indicate the start of RSPA, and “action id=4” may indicate the rest of the target location for RSPA.

function status value may be set to one of 0 to 3. For example, “function status=0” may indicate the deactivation of RSPA, “function status=1” may indicate the activation of RSPA (i.e., transmitting the distance measurement/AoA result to the key fob/device and/or preparing for moving to the target location), “function status=2” may indicate the stop of RSPA, and “function status=3” may indicate the start of RSPA.

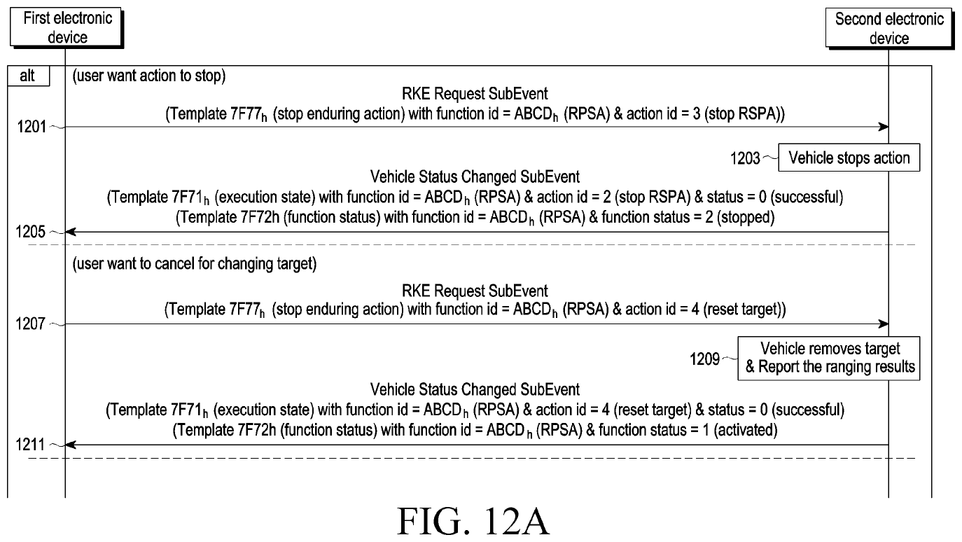

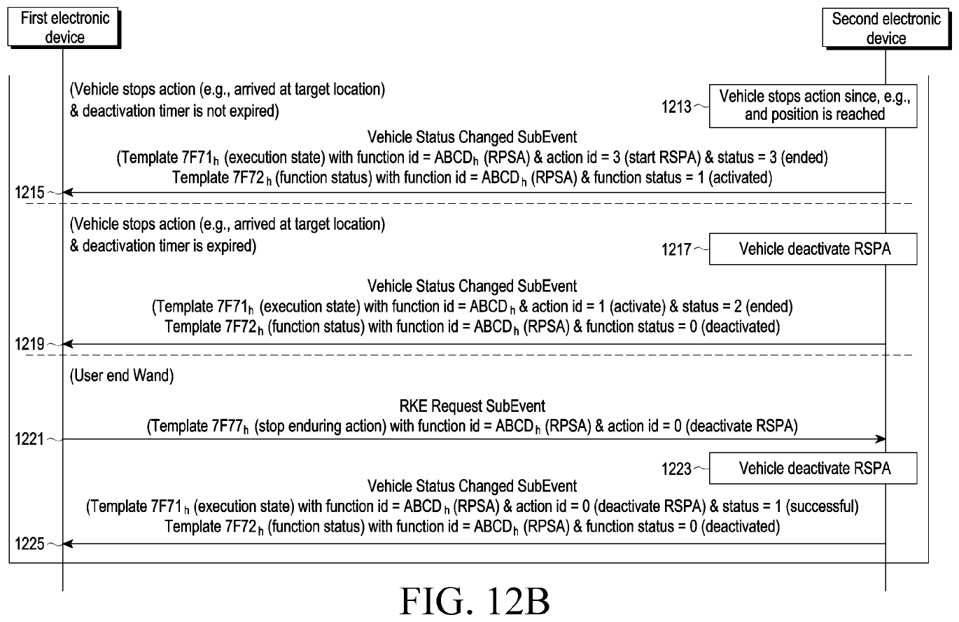

FIGS. 12A and 12B are flowcharts illustrating a process of performing an operation related to autonomous driving-based parking according to a user request according to an embodiment of the disclosure.

FIGS. 12A and 12B regard embodiments of stopping autonomous driving-based parking (RSPA) (Stop RSPA), changing the target location for RSPA (Reset Target), and terminating RSPA after the second electronic device (e.g., a vehicle) arrives at the target location (End RPSA) or explicitly by the user (Deactivate RSPA).

According to an embodiment, the second electronic device (e.g., a vehicle) may execute the deactivation timer after arriving at the target location. According to an embodiment, when the user sets the next target location, the second electronic device (e.g., a vehicle) may wait for RSPA and, when the deactivation timer expires, deactivate RSPA.

Referring to FIG. 12A, in step 1201, the first electronic device (e.g., a smartphone) may transmit, to the second electronic device (e.g., a vehicle), a message (RKE Request SubEvent) for requesting to stop autonomous driving-based parking (RSPA). For example, the RKE Request SubEvent message may be Template 7F77ₕ for stopping the enduring action in which “function id=ABCDₕ(RSPA) and action id=2 (stop RSPA)”.

In step 1203, the second electronic device (e.g., a vehicle) may stop the autonomous driving-based parking (RSPA) function (vehicle stops action).

In step 1205, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the autonomous driving-based parking (RSPA) function of the second electronic device is successfully stopped.

For example, the Vehicle Status Changed SubEvent message may be Template 7F71ₕ for the execution state in which “function id=ABCDₕ(RSPA) and action id=2 (stop RSPA) and status=0 (successful)”. For example, the Vehicle Status Changed SubEvent message may be Template 7F72ₕ for the function status in which “function id=ABCDₕ(RSPA) and function status=2 (stopped)”.

In step 1207, the first electronic device (e.g., a smartphone) may transmit, to the second electronic device (e.g., a vehicle), a message (RKE Request SubEvent) for resetting the target location for autonomous driving-based parking (RSPA). For example, the RKE Request SubEvent message may be Template 7F77ₕ for stopping the enduring action in which “function id=ABCDₕ(RSPA) and action id=4 (reset RSPA)”.

In step 1209, the second electronic device (e.g., a vehicle) may remove the target location for autonomous driving-based parking (RSPA) and report the ranging results.

In step 1211, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the target location for autonomous driving-based parking (RSPA) of the second electronic device is successfully reset.

For example, the Vehicle Status Changed SubEvent message may be Template 7F71ₕ for the execution state in which “function id=ABCDₕ(RSPA) and action id=4 (reset target) and status=0 (successful)”. For example, the Vehicle Status Changed SubEvent message may be Template 7F72ₕ for the function status in which “function id=ABCDₕ(RSPA) and function status=1 (activated)”.

According to an embodiment, the above-described 1) steps 1201 to 1205 and 2) steps 1207 to 1211 each may be performed independently according to the user's request.

According to an embodiment, the above-described 1) steps 1201 to 1205 and 2) steps 1207 to 1211 may be sequentially performed, but the technical spirit of the disclosure is not limited to 1) steps 1201 to 1205 and 2) steps 1207 to 1211 being sequentially performed.

Referring to FIG. 12B, in step 1213, the second electronic device (e.g., a vehicle) may stop the autonomous driving-based parking (RSPA) function (vehicle stops action). For example, the second electronic device (e.g., a vehicle) may stop the autonomous driving-based parking (RSPA) function in a state in which the second electronic device moves to the target location (arrived at target location), and the deactivation timer does not expire.

In step 1215, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the autonomous driving-based parking (RSPA) of the second electronic device is terminated or is still active.

For example, the Vehicle Status Changed SubEvent message may be Template 7F71ₕ for the execution state in which “function id=ABCDₕ(RSPA) and action id=3 (stop RSPA) and status=3 (ended)”. For example, the Vehicle Status Changed SubEvent message may be Template 7F72ₕ for the function status in which “function id=ABCDₕ(RSPA) and function status=1 (activated)”.

In step 1217, the second electronic device (e.g., a vehicle) may deactivate the autonomous driving-based parking (RSPA) function (vehicle deactivate RSPA). For example, the second electronic device (e.g., a vehicle) may deactivate the autonomous driving-based parking (RSPA) function in a state in which the second electronic device moves to the target location (arrived at target location), and the deactivation timer expires.

In step 1219, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the autonomous driving-based parking (RSPA) of the second electronic device is terminated or deactivated.

For example, the Vehicle Status Changed SubEvent message may be Template 7F71ₕ for the execution state in which “function id=ABCDₕ(RSPA) and action id=3 (stop RSPA) and status=2 (ended)”. For example, the Vehicle Status Changed SubEvent message may be Template 7F72ₕ for the function status in which “function id=ABCDₕ(RSPA) and function status=1 (deactivated)”.

In step 1221, the first electronic device (e.g., a smartphone) may transmit, to the second electronic device (e.g., a vehicle), a message (RKE Request SubEvent) for terminating autonomous driving-based parking (RSPA). For example, the RKE Request SubEvent message may be Template 7F77ₕ for stopping the enduring action in which “function id=ABCDₕ(RSPA) and action id=0 (deactivate RSPA)”.

In step 1223, the second electronic device (e.g., a vehicle) may deactivate the autonomous driving-based parking (RSPA) function.

In step 1225, the second electronic device (e.g., a vehicle) may transmit a message (Vehicle Status Changed SubEvent) indicating that the status of the vehicle is changed to the first electronic device (e.g., a smartphone). According to an embodiment, the Vehicle Status Changed SubEvent message may indicate that the autonomous driving-based parking (RSPA) function of the second electronic device is successfully deactivated.

For example, the Vehicle Status Changed SubEvent message may be Template 7F71ₕ for the execution state in which “function id=ABCDₕ(RSPA) and action id=1 (deactivate RSPA) and status=1 (successful)”. For example, the Vehicle Status Changed SubEvent message may be Template 7F72ₕ for the function status in which “function id=ABCDₕ(RSPA) and function status=0 (deactivated)”.

According to an embodiment, the above-described 1) steps 1213 to 1215, 2) steps 1217 to 1219, and 3) steps 1221 to 1225 each may be performed independently.

According to an embodiment, the above-described 1) steps 1213 to 1215, 2) steps 1217 to 1219, and 3) steps 1221 to 1225 may be sequentially performed, but the technical spirit of the disclosure is not limited to 1) steps 1213 to 1215, 2) steps 1217 to 1219, and 3) steps 1221 to 1225 being sequentially performed.

According to an embodiment, the deactivation timer may be maintained without expiring until there is a deactivation request for the electronic device for quick RSPA. According to an embodiment, when the RSPA for the electronic device is not operated in the foreground, it may be deactivated. According to an embodiment, the deactivation timer may also be operated during the standby time from activation of RSPA to the start of RSPA. According to an embodiment, the same deactivation timer as the standby time from activation of RSPA to deactivation may be operated. However, the standby time from activation to the start of RSPA may be longer than the standby time from the termination of RSPA to deactivation.

According to an embodiment, as the BLE message for the second electronic device (e.g., a vehicle) to transmit the UWB ranging result to the first electronic device (e.g., a smartphone), the 3rd Party App Message defined in CCC Digital Key Phase 3 may be used. The 3rd Party App Message is a message that is exchanged on the L2 CAP channel for the digital key service and is one for being transferred to the Vehicle OEM's App and the Vehicle. It may be transferred to the Native or Vehicle OEM App in the Device or the Wand-dedicated App for Wand operation, in addition to the Vehicle OEM's App.

Tables 2 and 3 below show the 3rd Part App Message structure for Wand. The second electronic device (e.g., a vehicle) may periodically transmit, to the first electronic device (e.g., a smartphone), the 3rd Part App Message in the RSPA activated state. Since the accuracy of designating the target location is varied depending on the location or direction (orientation) of the first electronic device (e.g., a smartphone), the transmission period of the 3rd Part App Message may be set to be the same as the UWB Ranging Block Size. According to an embodiment, the 3rd Part App Message may be transmitted immediately after the second electronic device (e.g., a vehicle) obtains the distance and/or direction information.

TABLE 2

| Message | Message ID | Parameters |
|---|---|---|
| Pass_through | 16 | Payload |

Referring to Table 2, the second electronic device (e.g., a vehicle) may periodically transmit, to the first electronic device (e.g., a smartphone), the Pass_through message in the RSPA activated state.

TABLE 3

| | Size | |
|---|---|---|
| Parameters | (Octets) | Description |
| Height | 2 | An unsigned integer that conveys the height of origin on |
| | | vehicle from the ground. The units of distance is 1 |
| | | centimeter (i.e., 1 cm) |
| Axis | 1 | 0: Clockwise, 1: Counter Clockwise others [symbol] TBD |
| Distance | 2 | An unsigned integer that conveys the distance estimate |
| | | between the device and the vehicle. The units of distance |
| | | is 1 centimeter (i.e., 1 cm) |
| AoA Azimuth | 2 | A signed integer reporting the estimated AOA in the |
| | | azimuth measured with respect to the device. The unit is |
| | | 2π/(2 [symbol] − 1), with 0 radians being directly in front of |
| | | the device. |
| AoA Elevation | 2 | A signed integer reporting the estimated AOA in the |
| | | elevation measured with respect to the addressed device |
| | | (see Address field description). The unit is π/(2 [symbol] − |
| | | 1), with 0 radians being in the horizontal plane of the |
| | | device. |
| Distance FoM | 1 | An unsigned integer that conveys the reliability of the |
| | | estimated distance. The value of zero means that the |
| | | distance estimate is invalid. 0xFF means that the value |
| | | is not available |
| AoA Azimuth FoM | 1 | An unsigned integer that conveys the reliability of the |
| | | estimated AOA in the azimuth. Higher AOA Azimuth FOM |
| | | field values indicate better quality AOA estimates, and |
| | | an AOA. Azimuth FOM field value of zero means that the |
| | | AOA Azimuth estimate is invalid. 0xFF means that the |
| | | value is not available |
| AoA Elevation | 1 | An unsigned integer that conveys the reliability of the |
| FoM | | estimated AOA in the elevation. Higher AOA Elevation FOM |
| | | field values indicate better quality AOA estimates, and |
| | | an AOA Elevation FOM field value of zero means that the |
| | | AOA Elevation estimate is invalid. 0xFF means that the |
| | | value is not available |

[symbol]

indicates data missing or illegible when filed

Referring to Table 3, the parameters included in the 3rd Part App Message (or Pass_through message) are 1) to 8) as follows.

### 1) Height

An unsigned integer that transfers the vehicle's origin height from the ground. The unit of distance may be, e.g., 1 centimeter.

### 2) Axis

0: Clockwise, 1: Counterclockwise, Others: to be discussed

### 3) Distance

May be an unsigned integer that transfers an estimate of the distance between the vehicle and another electronic device. The unit of distance may be, e.g., 1 centimeter.

### 4) AoA Azimuth

A signed integer reporting the AOA estimated from the azimuth measured for the electronic device, and the unit may be, e.g., 2π/(2¹⁶−1) and 0 radians may mean being directly in front of the device.

### 5) AoA Elevation

A signed integer reporting the expected AOA of the altitude measured in relation to an addressed electronic device, and the unit may be π/(2¹⁶−1) and 0 radians may be on the horizontal plane of the electronic device.

### 6) Distance FoM

An unsigned integer that transfers the credibility in the expected distance. For example, 0 may mean that the distance estimate is invalid, or 0xFF may mean that the value is not available.

### 7) AoA Azimuth FoM)

An unsigned integer that transfers the credibility of the estimated AOA in azimuth, where a higher AOA azimuth FOM field value may indicate a better quality AOA estimate and AOA. An azimuth FOM field value of 0 may mean that the AOA azimuth estimate is invalid, and 0xFF may indicate that the value is not available.

### 8) AoA Elevation FoM

An unsigned integer that transfers the credibility of the estimated AOA in altitude, where a higher AOA elevation FOM field value may indicate better quality AOA estimation. An AOA elevation FOM field value of 0 may mean that the AOA elevation estimation is invalid, and 0xFF may indicate that the value is not available.

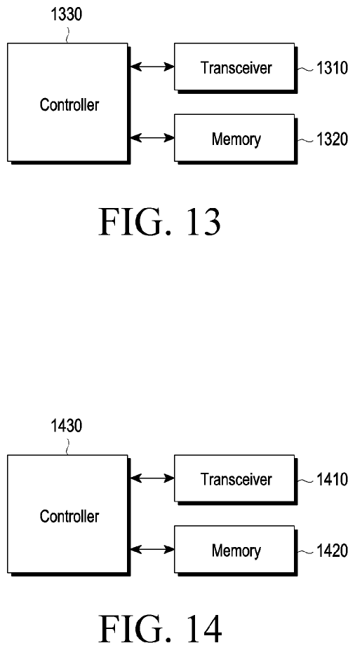

FIG. 13 illustrates a structure of a first electronic device according to an embodiment of the disclosure.

The first electronic device of FIG. 13 may be the electronic device of FIG. 1, the first electronic device or the second electronic device of FIG. 2, the first electronic device or the second electronic device of FIG. 3, or the first electronic device described with reference to FIGS. 4 to 12B. Referring to FIG. 13, the first electronic device may include a transceiver 1310, memory 1320, and a controller 1330.

The transceiver 1310, controller 1330, and memory 1320 of the first electronic device may be operated according to the above-described device communication method. However, the components of the first electronic device are not limited thereto. For example, the first electronic device may include more or fewer components than the above-described components. The transceiver 1310, the controller 1330, and the memory 1320 may be implemented in the form of a single chip. The controller 1330 may include one or more processors.

The transceiver 1310 collectively refers to a receiver of the first electronic device and a transmitter of the electronic device and may transmit and receive signals to/from another device. To that end, the transceiver 1310 may include a radio frequency (RF) transmitter for frequency-up converting and amplifying signals transmitted and an RF receiver for low-noise amplifying signals received and frequency-down converting the frequency of the received signals. However, this is merely an embodiment of the transceiver 1310, and the components of the transceiver 1310 are not limited to the RF transmitter and the RF receiver.

The transceiver 1310 may receive signals via a radio channel, output the signals to the controller 1330, and transmit signals output from the controller 1330 via a radio channel.

The memory 1320 may store programs and data necessary for the operation of the first electronic device. Further, the memory 1320 may store control information or data that is included in the signal obtained by the first electronic device. The memory 1320 may include a storage medium, such as ROM, RAM, hard disk, CD-ROM, and DVD, or a combination of storage media. Rather than being separately provided, the memory 1320 may be embedded in the controller 1330.

The controller 1330 may control a series of processes for the first electronic device to be able to operate according to the above-described embodiments of the disclosure.

The controller 1330 may control to transmit, to the second electronic device, a first message for activating autonomous driving-based parking (RSPA) of the second electronic device (e.g., a vehicle). The controller 1330 may control to receive, from the second electronic device, measurement information about ultra-wideband (UWB) ranging performed by the second electronic device. The controller 1330 may determine a target location where the second electronic device is to perform the autonomous driving-based parking based on the measurement information about the UWB ranging. The controller 1330 may control to instruct the second electronic device to start the autonomous driving-based parking and transmit a second message including information about the target location to the second electronic device.

FIG. 14 illustrates a structure of a second electronic device according to an embodiment of the disclosure.

The first electronic device of FIG. 14 may be the electronic device of FIG. 2, the first electronic device or the second electronic device of FIG. 2, the first electronic device or the second electronic device of FIG. 3, or the second electronic device described with reference to FIGS. 4 to 12B. Referring to FIG. 14, the second electronic device may include a transceiver 1410, memory 1420, and a controller 1430.

The transceiver 1410, controller 1430, and memory 1420 of the second electronic device may be operated according to the above-described device communication method. However, the components of the second electronic device are not limited thereto. For example, the second electronic device may include more or fewer components than the above-described components. The transceiver 1410, the controller 1430, and the memory 1420 may be implemented in the form of a single chip. The controller 1430 may include one or more processors.

The transceiver 1410 collectively refers to a receiver of the second electronic device and a transmitter of the electronic device and may transmit and receive signals to/from another device. To that end, the transceiver 1410 may include a radio frequency (RF) transmitter for frequency-up converting and amplifying signals transmitted and an RF receiver for low-noise amplifying signals received and frequency-down converting the frequency of the received signals. However, this is merely an embodiment of the transceiver 1410, and the components of the transceiver 1410 are not limited to the RF transmitter and the RF receiver.

The transceiver 1410 may receive signals via a radio channel, output the signals to the controller 1430, and transmit signals output from the controller 1430 via a radio channel.

The memory 1420 may store programs and data necessary for the operation of the second electronic device. Further, the memory 1420 may store control information or data that is included in the signal obtained by the second electronic device. The memory 1420 may include a storage medium, such as ROM, RAM, hard disk, CD-ROM, and DVD, or a combination of storage media. Rather than being separately provided, the memory 1420 may be embedded in the controller 1430.

The controller 1430 may control a series of processes for the second electronic device to be able to operate according to the above-described embodiments of the disclosure.

The controller 1430 may control to receive, from a first electronic device (e.g., a mobile terminal), a first message for activating autonomous driving-based parking (RSPA) of the second electronic device. The controller 1430 may control to transmit, to the first electronic device, measurement information about ultra-wideband (UWB) ranging performed by the second electronic device. The controller 1430 may control to instruct the second electronic device to start the autonomous driving-based parking and receive, from the first electronic device, a second message including information about the target location where the second electronic device is to perform the autonomous driving-based parking.

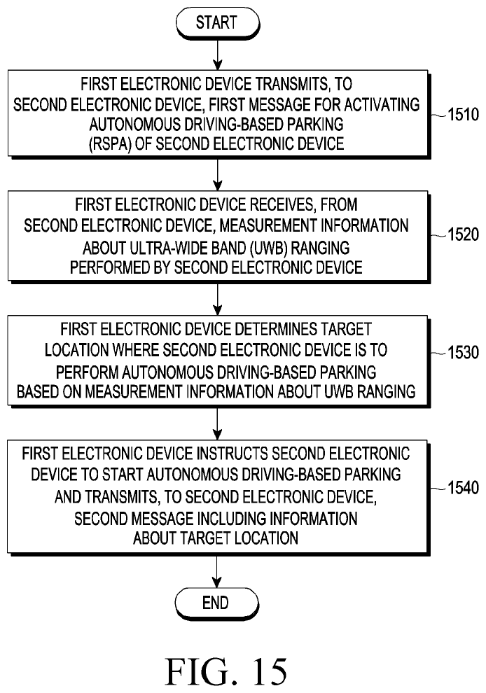

FIG. 15 is a flowchart illustrating an operation method of a first electronic device according to an embodiment of the disclosure.

Referring to FIG. 15, in step 1510, the first electronic device may transmit, to the second electronic device, a first message for activating autonomous driving-based parking (RSPA) of the second electronic device. According to an embodiment, the first electronic device may be a mobile terminal, and the second electronic device may be a vehicle.

In step 1520, the first electronic device may receive, from the second electronic device, measurement information about ultra-wideband (UWB) ranging performed by the second electronic device. According to an embodiment, the measurement information about the UWB ranging may include at least one of a distance (height) from a center point in the second electronic device to a ground, a distance from the center point in the second electronic device to the first electronic device, an angle of arrival (AOA) azimuth for the first electronic device from the center point in the second electronic device, and an AoA elevation value for the first electronic device from the center point of the second electronic device.

In step 1530, the first electronic device may determine a target location where the second electronic device is to perform the autonomous driving-based parking based on the measurement information about the UWB ranging.

In step 1540, the first electronic device may instruct the second electronic device to start the autonomous driving-based parking and transmit a second message including information about the target location to the second electronic device.

According to an embodiment, the first electronic device may transmit, to the second electronic device, a third message for instructing the second electronic device to reset the target location for the autonomous driving-based parking.

According to an embodiment, when the second electronic device arrives at the target location, and the deactivation timer does not expire, the first electronic device may receive, from the second electronic device, a fourth message for instructing the second electronic device to stop moving.

According to an embodiment, when the second electronic device arrives at the target location, and the deactivation timer expires, the first electronic device may receive, from the second electronic device, a fifth message for indicating that the autonomous driving-based parking of the second electronic device is deactivated.

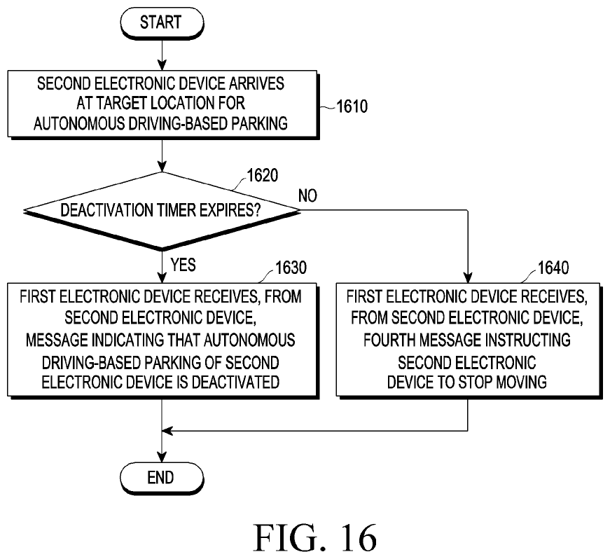

FIG. 16 is a flowchart illustrating an operation method of a second electronic device according to an embodiment of the disclosure.

In step 1610, the second electronic device may perform autonomous driving-based parking to arrive at the target location set by the first electronic device.

In step 1620, the second electronic device may determine whether the deactivation timer regarding autonomous driving-based parking expires.

If the deactivation timer expires (yes in 1620) in step 1620, in step 1630, the first electronic device may receive, from the second electronic device, a message indicating that the autonomous driving-based parking of the second electronic device is deactivated.

If the deactivation timer does not expire (no in 1620) in step 1620, in step 1640, the first electronic device may receive, from the second electronic device, a fourth message for instructing the second electronic device to stop moving. According to an embodiment, the second electronic device may maintain the active state for the autonomous driving-based parking function until before the deactivation timer expires. According to an embodiment, the second electronic device may perform autonomous driving-based parking to move a target location changed in response to a target location change request of the first electronic device before the deactivation timer expires.

In the above-described specific embodiments of the present invention, the components included in the disclosure are represented in singular or plural forms depending on specific embodiments proposed. However, the singular or plural forms are selected to be adequate for contexts suggested for ease of description, and the present invention is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for an operation by a first electronic device in a wireless communication system, the method comprising:
transmitting, to a second electronic device, a first message for activating autonomous driving-based parking (RSPA) of the second electronic device;
receiving, from the second electronic device, measurement information for ultra-wideband (UWB) ranging performed by the second electronic device;
determining a target location where the second electronic device is to perform the autonomous driving-based parking based on the measurement information about the UWB ranging; and
transmitting, to the second electronic device, a second message instructing the second electronic device to start the autonomous driving-based parking and including information about the target location.

2. The method of claim 1, further comprising transmitting, to the second electronic device, a third message instructing the second electronic device to reset the target location for the autonomous driving-based parking.

3. The method of claim 1, further comprising, when the second electronic device arrives at the target location and a deactivation timer does not expire, receiving, from the second electronic device, a fourth message instructing the second electronic device to stop moving.

4. The method of claim 1, further comprising, when the second electronic device arrives at the target location and a deactivation timer expires, receiving, from the second electronic device, a fifth message indicating that the autonomous driving-based parking of the second electronic device is deactivated.

5. The method of claim 1, wherein the measurement information about the UWB ranging includes at least one of a distance (height) from a center point in the second electronic device to a ground, a distance from the center point in the second electronic device to the first electronic device, an angle of arrival (AOA) azimuth for the first electronic device from the center point in the second electronic device, and an AoA elevation value for the first electronic device from the center point of the second electronic device.

6. The method of claim 1, wherein the first electronic device is a mobile terminal, and the second electronic device is a vehicle.

7. A method for an operation by a second electronic device in a wireless communication system, the method comprising:
receiving, from a first electronic device, a first message for activating autonomous driving-based parking (RSPA) of the second electronic device;
transmitting, to the first electronic device, measurement information for ultra-wideband (UWB) ranging performed by the second electronic device; and
receiving, from the first electronic device, a second message instructing the second electronic device to start the autonomous driving-based parking and including information about a target location where the second electronic device is to perform the autonomous driving-based parking.

8. The method of claim 7, further comprising receiving, from the first electronic device, a third message instructing the second electronic device to reset the target location for the autonomous driving-based parking.

9. The method of claim 7, further comprising, when the second electronic device arrives at the target location and a deactivation timer does not expire, transmitting, to the first electronic device, a fourth message instructing the second electronic device to stop moving.

10. The method of claim 7, further comprising, when the second electronic device arrives at the target location and a deactivation timer expires, transmitting, to the first electronic device, a fifth message indicating that the autonomous driving-based parking of the second electronic device is deactivated.

11. A first electronic device in a wireless communication system, comprising:
a transceiver; and
a controller, wherein the controller coupled with the transceiver and configured to control to:
transmit, to a second electronic device, a first message for activating autonomous driving-based parking (RSPA) of the second electronic device;
receive, from the second electronic device, measurement information for ultra-wideband (UWB) ranging performed by the second electronic device;
determine a target location where the second electronic device is to perform the autonomous driving-based parking based on the measurement information about the UWB ranging; and
transmit, to the second electronic device, a second message instructing the second electronic device to start the autonomous driving-based parking and including information about the target location.

12. The first electronic device of claim 11, wherein the controller is configured to control to transmit, to the second electronic device, a third message instructing the second electronic device to reset the target location for the autonomous driving-based parking.

13. The first electronic device of claim 11, wherein the controller is configured to, when the second electronic device arrives at the target location and a deactivation timer does not expire, control to receive, from the second electronic device, a fourth message instructing the second electronic device to stop moving.

14. A second electronic device in a wireless communication system, comprising:
a transceiver; and
a controller, wherein the controller coupled with the transceiver and configured to control to:
receive, from a first electronic device, a first message for activating autonomous driving-based parking (RSPA) of the second electronic device;
transmit, to the first electronic device, measurement information for ultra-wideband (UWB) ranging performed by the second electronic device; and
receive, from the first electronic device, a second message instructing the second electronic device to start the autonomous driving-based parking and including information about a target location where the second electronic device is to perform the autonomous driving-based parking.

15. The second electronic device of claim 14, wherein the controller is configured to control to receive, from the first electronic device, a third message instructing the second electronic device to reset the target location for the autonomous driving-based parking.
